(19) United States
(12) Patent Application Publication
(10) Pub. No.: US 2016/0201851 A1
(43) Pub. Date: Jul. 14, 2016

(54) RECEPTACLE FOR CHARGING HYDROGEN

(71) Applicants: Hyundai Motor Company, Seoul (KR); Kia Motors Corporation, Seoul (KR)

(72) Inventors: Sang Hyun Kim, Seongnam (KR); Ji Hyun Shim, Seoul (KR); Ki Ho Hwang, Seoul (KR)

(21) Appl. No.: 14/936,287

(22) Filed: Nov. 9, 2015

(30) Foreign Application Priority Data
Jan. 13, 2015 (KR) 10-2015-0004592

(51) Int. Cl. F17C 5/00; F17C 13/04; B65D 83/42; H01M 8/04082

(52) U.S. Cl. CPC F17C 5/007; H01M 8/04201; F17C 13/04; B65D 83/425; H01M 2250/20

(57) ABSTRACT

A receptacle for charging hydrogen is provided. The receptacle includes a main body formed at one side of a vehicle. A filter unit disposed within the main body filters the foreign substance in the hydrogen gas passing through the main body and a check unit disposed at the rear end of the filter unit controls a flow in one direction. The filter unit includes a mesh filter inserted into the filter socket formed at a first body of the main body and formed in a shape to filter the hydrogen gas passing through the main body, and a filter supporter disposed at the rear side of the mesh filter to closely support the mesh filter by coupling the second body and the first body and of which a plurality of gas apertures are formed to cause hydrogen gas passing through the mesh filter to flow to the check unit side.

### CROSS-REFERENCE TO RELATED APPLICATION

This application claims under 35 U.S.C. §119(a) the benefit of Korean Patent Application No. 10-2015-0004592 filed on January 13, 2015, the entire contents of which are incorporated herein by reference.

### BACKGROUND

(a) Technical Field

The present invention relates to a receptacle for charging hydrogen, and more particularly, to a receptacle for charging hydrogen which efficiently charges hydrogen gas in a hydrogen tank of a hydrogen vehicle by preventing foreign substances from flowing by filtering and suppressing the occurrence of differential pressure.

(b) Background Art

Generally, a hydrogen vehicle operates by obtaining electricity when oxygen which is an oxidizing gas chemically reacts with hydrogen gas which is a fuel gas in a fuel cell. In addition, a fuel cell electric vehicle operates using the fuel cell instead of an engine and a hydrogen fuel vehicle which directly combusts hydrogen gas in the engine similar to a general gasoline vehicle.

The hydrogen vehicle charges the hydrogen gas by installing a hydrogen tank within the vehicle use the hydrogen gas as a fuel and may include a plurality of hydrogen tanks which withstand pressure of the hydrogen gas at 350 atm or 700 atm. Particularly, a system of charging hydrogen gas in the hydrogen tank measures pressure using a pressure sensor mounted in each of a buffer tank of a hydrogen gas station and a hydrogen tank of the hydrogen vehicle to complete charging when the measured pressure reaches target pressure. A receptacle that charges hydrogen is used as a type of connector which connects the buffer tank and the hydrogen tank to each other while the hydrogen gas is charged.

Meanwhile, in the hydrogen gas charging of the hydrogen vehicle, as defined by the international protocol (SAE2601), it is defined that hydrogen gas of 4 to 7 kg is required to be charged within 3 minutes, but charging speeds of a vehicle having a storage amount of hydrogen gas of 4 kg and a vehicle having a storage amount of hydrogen gas of 7 kg are different from each other. In other words, the charging speed of the vehicle having a storage amount of hydrogen gas of 7 kg is faster, but a pressure difference (differential pressure) between the charging station and the vehicle is generated due to the rapid charging speed.

Accordingly, a receptacle for charging hydrogen in the related art is connected with a charging nozzle of the buffer tank included in the hydrogen gas station to inject the hydrogen gas into the hydrogen tank of the hydrogen vehicle, and a filter is required to be installed therein as a component included extraneous to the vehicle to prevent foreign substances such as dust from flowing into the hydrogen tank of the vehicle while the hydrogen gas is charged.

Accordingly, a technique in the related art of preventing the foreign substances from flowing into the hydrogen tank through the filter includes a filter part 10 configured to filter a foreign substance of hydrogen gas, a ring-type porous supporter 12 that couples and supports the filter part 10 with a valve 20 in the receptacle filter for charging high-pressure hydrogen including the valve 20 to operate one-way flow of the hydrogen gas, and a metal powder filter member 14 integrally formed on the entire surface of the ring-type porous supporter 12 and heating and sintering a metal powder at a predetermined temperature to filter the foreign substance while the hydrogen gas is charged.

Meanwhile, recently, in the hydrogen vehicle, a high-pressure hydrogen storage system at 700 atm with highest commercialization performance tends to be installed. Accordingly, to store the high-pressure hydrogen gas stored in the hydrogen tank of the hydrogen vehicle at a pressure of 700 atm, the hydrogen gas is required to be charged at a pressure of 700 atm or greater in the charging station.

However, in the related art, due to functional performance of the filter, the foreign substance may be prevented from flowing while the hydrogen gas is charged, but a differential pressure is generated due to a pressure of the buffer tank at the charging station side which is lower than a demand pressure of the storage tank at the vehicle. The differential pressure significantly influences the charging speed, and particularly a state of fuel (SOF) while charging stops at a predetermined pressure is charged lower than the demand level due to a capacity shortage of the charging station. Further, to remove a filter to reduce generation of the differential pressure between the buffer tank at the charging station side and the hydrogen tank at the vehicle, charging efficiency may be increased, but it is exposed to flowing of the foreign substance by removing the filter.

The above information disclosed in this section is merely for enhancement of understanding of the background of the invention and therefore it may contain information that does not form the prior art that is already known in this country to a person of ordinary skill in the art.

### SUMMARY

The present invention provides a receptacle for charging hydrogen having advantages of efficiently charging hydrogen gas by applying a mesh filter to the receptacle for charging hydrogen and including a porous supporter that prevents deformation of the mesh filter to prevent a foreign substance from flowing while hydrogen gas is charged in a hydrogen tank of a hydrogen vehicle and suppress the occurrence of a differential pressure.

In one aspect, the present invention provides a receptacle for charging hydrogen in which a charging nozzle at the charging station side of the hydrogen gas is connected to the hydrogen vehicle to charge the hydrogen gas in the hydrogen tank of the hydrogen vehicle from the buffer tank of the hydrogen gas charging station. The receptacle may include a main body of the receptacle formed at one side of a hydrogen vehicle and configured as a connector of a charging nozzle at a hydrogen gas charging station side; a filter unit disposed within the main body of the receptacle and configured to filter the foreign substance in the hydrogen gas passing through the main body of the receptacle; and a check unit disposed at the rear end of the filter unit and configured to adjust a flow in one direction.

In an exemplary embodiment, the filter unit may include a mesh filter inserted to the filter socket formed at a first body of the main body of the receptacle and formed in a network shape to filter the hydrogen gas passing through the main body of the receptacle, and a filter supporter disposed at the rear side of the mesh filter to closely support the mesh filter through coupling of the second body and the first body of the main body of the receptacle and of which a plurality of gas apertures are formed through to cause the hydrogen gas passing through the mesh filter to flow to the check unit side.

According to the exemplary embodiment of the present invention configured above, it may be possible to more efficiently charge hydrogen gas by preventing a foreign substance from flowing while hydrogen gas is charged in a hydrogen tank of a hydrogen vehicle and suppressing the occurrence of a differential pressure.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is a diagram illustrating a receptacle for charging hydrogen according to the related art;

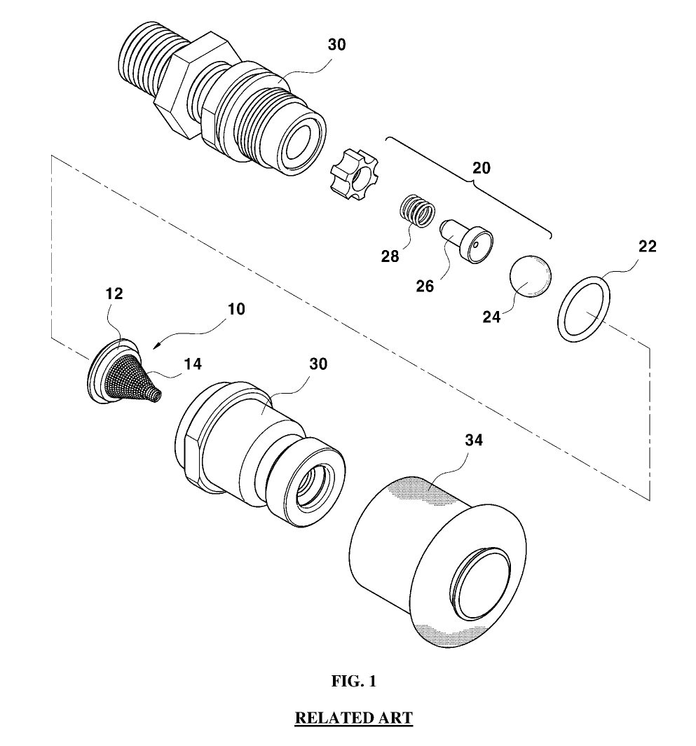

FIG. 2 is a diagram of a first exemplary embodiment of a receptacle for charging hydrogen according to an exemplary embodiment of the present invention;

FIG. 3 is a cross-sectional diagram of the first exemplary embodiment of the receptacle for charging hydrogen according to an exemplary embodiment of the present invention;

FIG. 4 is a cross-sectional diagram of a second exemplary embodiment of the receptacle for charging hydrogen according to an exemplary embodiment of the present invention; and

FIG. 5 is a comparison graph between the related art and the present invention with respect to a differential pressure and a charging amount according to a storage amount of a charging station.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

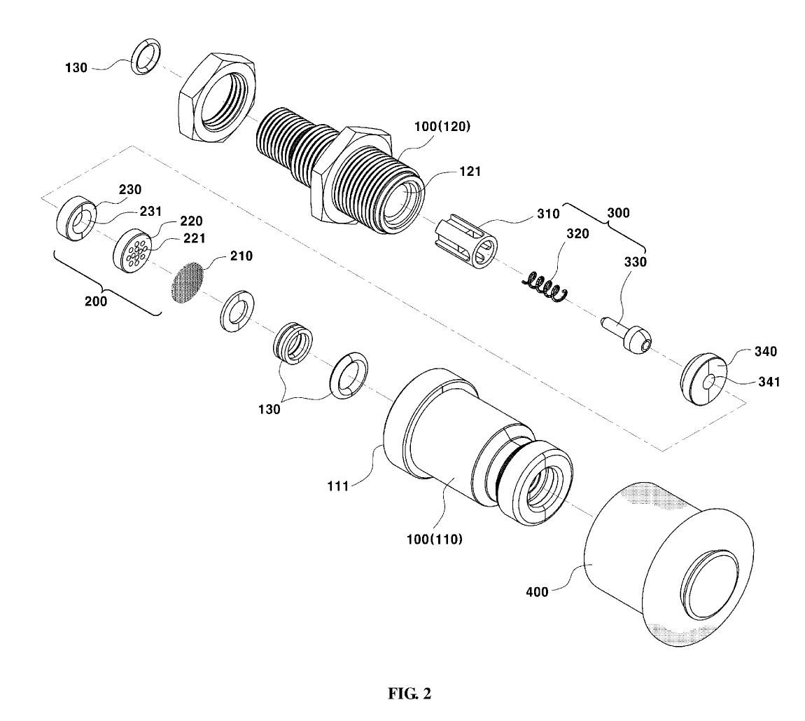

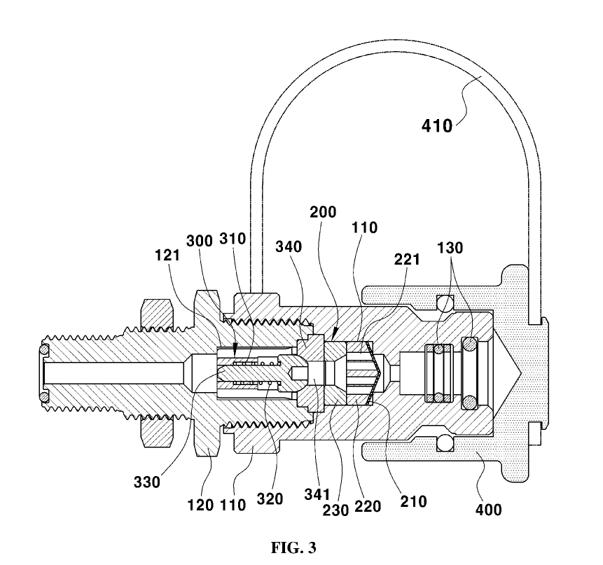

The present invention will be described more fully hereinafter with reference to the accompanying drawings, in which exemplary embodiments of the invention are shown. With reference to FIG. 2 illustrating a diagram of a receptacle for charging hydrogen according to the present invention and FIG. 3 illustrating a cross-sectional diagram of the receptacle for charging hydrogen according to the present invention, a receptacle for charging hydrogen may be used as a type of connector while hydrogen gas may be charged in a hydrogen tank of a hydrogen vehicle.

In particular, a filter unit 200 configured to filter a foreign substance in a main body 100 of the receptacle and a check unit 300 configured to adjust a flow of the hydrogen gas in which the foreign substance is filtered in one direction may be subsequently installed. The check unit 300 may be operated by a controller having a processor and a memory). In other words, the receptacle for charging hydrogen in which a charging nozzle at the charging station side of the hydrogen gas is connected to the hydrogen vehicle to charge the hydrogen gas in the hydrogen tank of the hydrogen vehicle from the buffer tank of the hydrogen gas charging station may be formed at one side (e.g., a first side) of the hydrogen vehicle.

Accordingly, the main body 100 of the receptacle operating as a connector of the charging nozzle at the hydrogen gas charging station side may be disposed at one side of the hydrogen vehicle. In particular, the main body 100 of the receptacle may include a hollow aperture in a length direction and may be divided into a first body 110 and a second body 120 to receive (e.g., accommodate) the filter unit 200 and the check unit 300 therein.

Meanwhile, the filter unit 200 configured to filter the foreign substance in the hydrogen gas passing through the main body 100 of the receptacle may be disposed within the main body 100 of the receptacle. In addition, the check unit 300 configured to prevent the hydrogen gas passing through the filter unit 200 from flowing backward in an opposite direction may be disposed at a rear end of the filter unit 200. Particularly, in the check unit 300, a valve plate 340 of which valve aperture 341 is formed through may be disposed at a rear end of the filter unit 200 and a control rod 330 in which a closing and opening ball 331 capable of opening and closing the valve hole 341 is formed may be disposed at the rear end of the valve plate 340.

In addition, a rod supporter 310 configured to limit a movement position of the control rod may be disposed in the main body 100 of the receptacle, and a spring 320 may be configured to provide elasticity between the control rod 330 and the rod supporter 310. The valve plate 340 side may be configured so that the closing and opening ball 331 of the control rod 330 blocks the valve aperture 341. In other words, the check unit 300 may be a check valve form to control the hydrogen gas to flow in one direction toward the hydrogen tank at the vehicle side from the buffer tank of the charging station side and may be inserted into a check socket 121 formed in the second body 120, but the hydrogen gas may pass there through.

Accordingly, the rod supporter 310 where the spring 320 is seated may be disposed within the second body 120, and the control rod 330 configured to open and close the valve aperture 341 of the valve plate 340 that covers the check socket 121 of the second body 120 may be elastically provided by the spring 320 seated at the rod supporter 310. The check unit 300 as configured above may integrally form a ball and a support aperture that supports the ball to reduce manufacturing cost compared to a structure of an existing check valve in the related art.

Particularly, when the valve aperture 341 is opened by pushing the ball portion of the control rod 330 that blocks the valve aperture 341 of the valve plate 340 by the spring 330 using a charging pressure of the hydrogen gas passing through the filter unit 200, the hydrogen gas may flow to the hydrogen tank side through a plurality of vent apertures 311 formed on the periphery of the rod supporter 310. When the charging pressure of the hydrogen gas at the buffer tank side is released or a supply valve is locked, the control rod 330 may contact (e.g., abut) the valve plate 340 by elastic restoring force of the spring 320 disposed within the rod supporter 310 to block the valve aperture 341 to prevent the hydrogen gas at the hydrogen tank from being discharged through the receptacle.

Further, the filter unit 200 may include a mesh filter 210 inserted into the filter socket 111 formed at the first body 110 of the main body 100 of the receptacle and formed in a network shape to filter the hydrogen gas passing through the main body 100 of the receptacle, and a filter supporter 220 disposed at the rear side of the mesh filter 210 to closely support the mesh filter 210 by coupling the second body 120 and the first body 110 of the main body 100 of the receptacle and of which a plurality of gas apertures 221 may be formed through to cause the hydrogen gas passing through the mesh filter 210 to flow to the check unit 330 side.

Referring to FIG. 3 illustrating the first exemplary embodiment according to the present invention, the filter unit 200 may be disposed at the front side of the check unit 300 to filter and pass the hydrogen gas through the mesh filter 210 preventing the foreign substance from flowing while the hydrogen gas is charged. In particular, the mesh filter 210 may be supported by the filter supporter 220 to prevent deformation of the mesh filter 210 by a pressure and a flow of the hydrogen gas passing through the mesh filter 210.

Moreover, at the rear side of the filter supporter 220 based on a flow direction of the hydrogen gas, a resistance coefficient plate 230 having a convergent aperture 231 with a width that decreases toward the rear side may be disposed to reduce the pressure drop when the hydrogen gas passes through the mesh filter 210. A convergent aperture having a width reduced in a direction where the hydrogen gas flows may be formed through the resistance coefficient plate 230. In particular, an inlet of the convergent aperture 231 may be formed widely at the front end of the resistance coefficient plate 230 contacting the rear side of the mesh filter 210, and an outlet may be formed narrowly (e.g., narrower than the inlet portion) to compress the hydrogen gas passing through the convergent aperture 231.

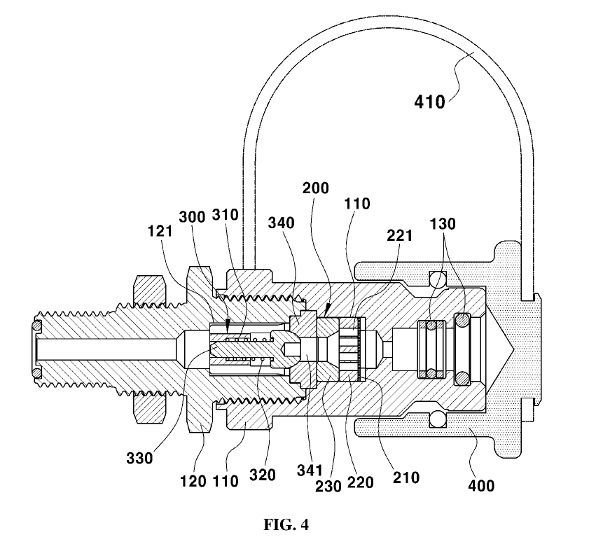

Meanwhile, as the cross-sectional configuration of the second exemplary embodiment of the receptacle for charging hydrogen according to the present invention, referring to FIG. 4 illustrating a modified shape of the filter unit 200, in the filter unit 200, the plurality of gas apertures 221 may be formed to support the mesh filter 210 and pass the hydrogen gas. Further, the filter unit 200 may be formed to be extended in a substantially conical shape in a flow direction of the hydrogen gas and further, may be variously formed in a substantially hemispherical shape, a curved shape, and the like to increase a filtering area in a flowing direction of the hydrogen gas.

Furthermore, the gas apertures 221 of the filter supporter 220 may be formed with a diameter substantial enough to vent about 3 to 6 apertures among the apertures of the mesh filter 210. In addition, a plurality of gas apertures 221 may be formed in various directions based on a shape of the filter supporter 220 and may be arranged at predetermined intervals between the gas apertures 221 to ensure stable support performance of the mesh filter 210. In other words, the mesh filter 210 may be formed in a substantially conical or curved shape to further ensure the filtering area of the charged hydrogen gas.

In addition, the filter supporter 220 may be formed in the conical or curved shape to correspond to the mesh filter 210 to support the mesh filter 210. Accordingly, the filter supporter 220 may be formed to project in the conical shape or the curved shape to maximize the filtering area of the mesh filter 210 to rapidly filter the hydrogen gas with a high capacity by increasing the corresponding area.

Moreover, the filter supporter may also be formed to project in either a conical shape or a curved shape to correspond to the shape of the mesh filter to correspondingly contact the mesh filter. In particular, a unit mesh size of the mesh filter 210 may be about 350 to 450 μm, and the gas aperture 221 of the filter supporter 220 may have a size of about 700 to 950 μm which may be large enough to pass three or more unit meshes of the mesh filter 210. Accordingly, hydrogen passing through the mesh filter 210 is not hindered by the gas aperture 221 and charged in the hydrogen tank at the vehicle side through the check unit 300.

Furthermore, a resistance coefficient plate 230 having a convergent aperture 231 inclined outward may be further disposed at the rear side of the filter supporter 220 to reduce a differential pressure of the hydrogen gas passing through the filer supporter 220. In addition, in the receptacle for charging hydrogen of the present invention, a plurality of sealing rings 130 may be provided to block leakage of the hydrogen gas. When an output nozzle is separated from the main body 100 of the receptacle after the hydrogen gas is charged, a protective cap 400 may be detachably disposed at the front side to prevent a foreign substance (e.g., any dust, particle, or other unwanted substance that provides a negative effect) from flowing through the first body 110, and a loss prevention tab 410 grasped at the second body 120 may be extended to prevent a loss of the protective cap 400 when being separated from one side of the protective cap 400.

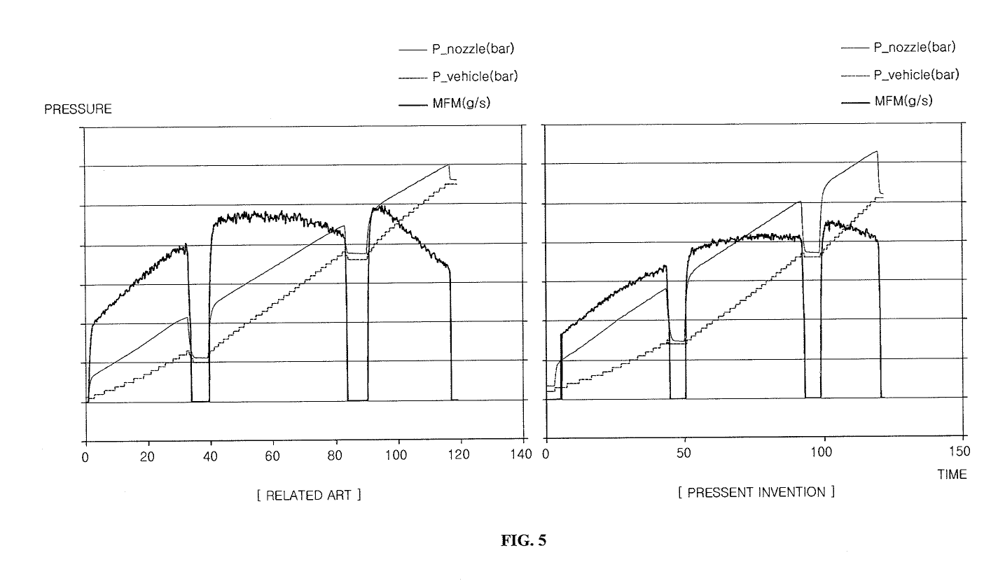

In the configuration of the present invention as discussed above, referring to FIG. 5 illustrating a comparison graph between the related art and the present invention with respect to a differential pressure and a charging amount based on a storage amount of a charging station, it can be seen that a differential pressure ΔP1 generated in the receptacle of the present invention is substantially less than a differential pressure ΔP2 generated in the receptacle in the related art.

In other words, the present invention has an improved filtering function using the mesh filter 210 and the filter supporter 220 included in the receptacle of the present invention, and compared to the related art, the differential pressure may be reduced as the charging speed is increased. Therefore, the present invention may prevent the foreign substance from flowing through filtering when the hydrogen gas is charged in the hydrogen tank of the hydrogen vehicle and efficiently charge the hydrogen gas without a differential pressure, thereby reducing a charging time.

Terms or words used in the present specification and claims, which will be described below should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A receptacle for charging hydrogen in a vehicle, comprising:
a main body of the receptacle connected with a charging nozzle configured to supply hydrogen gas;
a filter unit disposed within the main body of the receptacle to filter a foreign substance of the hydrogen gas passing there through;
a mesh filter disposed within the main body of the receptacle and configured in a network shape to pass the hydrogen gas through the filter unit; and
a filter supporter configured to supply the mesh filter and having a plurality of gas apertures through which the hydrogen gas flows to pass through the mesh filter.

2. The receptacle for charging hydrogen of claim 1, wherein a resistance coefficient plate in which a convergent aperture is formed to have a width decreasing in a direction where the hydrogen gas flows is disposed at one side of the filter supporter.

3. The receptacle for charging hydrogen of claim 1, wherein the gas apertures of the filter supporter are formed with a diameter having a size substantial enough to vent 3 to 6 apertures among the apertures of the mesh filter.

4. The receptacle for charging hydrogen of claim 1, wherein the mesh filter is formed in either a conical shape or a curved shape to maximize a filtering area.

5. The receptacle for charging hydrogen of claim 4, wherein the mesh filter is formed in either a conical shape or a curved shape to correspond to the shape of the mesh filter to correspondingly contact the mesh filter.

6. The receptacle for charging hydrogen of claim 2, wherein a check unit configured to prevent the hydrogen gas passing through the filter unit from flowing backward in an opposite direction is disposed within the main body of the receptacle.

7. The receptacle for charging hydrogen of claim 6, wherein: the check unit includes:
a valve plate disposed at a next position of the filter unit and having a valve aperture formed there through;
a control rod disposed at the next position of the valve plate and having a closing and opening ball configured to open and close the valve aperture formed at one end;
a rod supporter disposed at the next position of the control rod and configured to limit a movement position of the control rod; and
a spring configured to provide elasticity between the control rod and the rod supporter and configured to contact the valve plate side to cause the closing and opening ball of the control rod to block the valve aperture.

8. The receptacle of claim 1, wherein the receptacle is disposed within a hydrogen vehicle.

9. The receptacle of claim 1, wherein the receptacle is disposed within a fuel cell vehicle.
